(19) United States
(12) Patent Application Publication
(10) Pub. No.: US 2022/0180630 A1
(43) Pub. Date: Jun. 9, 2022

(54) RESUDUE ANALYSIS AND MANAGEMENT SYSTEM

(71) Applicant: Intelinair, Inc., Champaign, IL (US)

(72) Inventors: Naira Hovakymian, Champaign, IL (US); Jennifer Hobb, Champaign, IL (US); Ivan Dozier, Champaign, IL (US)

(73) Assignee: Intelinair, Inc., Champaign, IL (US)

(21) Appl. No.: 17/541,789

(22) Filed: Dec. 3, 2021

Related U.S. Application Data
(60) Provisional application No. 63/121,694, filed on Dec. 4, 2020.

(51) Int. Cl. G06V 20/10; G06T 11/00; G06V 20/17; G06V 10/10; H04N 9/07; B64C 39/02; B64D 47/08

(52) U.S. Cl. CPC G06V 20/188; G06T 11/00; G06V 20/17; B64C 2201/127; H04N 9/07; B64C 39/024; B64D 47/08; G06V 10/16

(57) ABSTRACT

A residue identification system including an image gathering unit that gathers at least one representation of a field and stiches the images together to produce a large single image of the field, an image analysis unit that generates residue map of the field and a residue analysis unit that processes the residue map to calculate a carbon emission of each area of the field.

### BACKGROUND OF THE INVENTION

Carbon sequestration is one of the primary topics raised in discussions around agriculture and climate change. Soils have the capacity to be an enormous carbon source or sink with farm management practices significantly impacting how much carbon is held in the soil. Many initiatives around carbon sequestration for cropland are heavily focused around tillage practice. Residues consist of crop biomass such as dried leaves and stalks leftover from harvest; these residues contain key nutrients which the plants had absorbed during the season. By reincorporating these residues back into the soil, usually via tilling, farmers are able to recycle those nutrients: as residues decompose, nutrients re-enter the soil, fueling the next year's crops. In contrast, “no-till” and alternative tillage practices limit the amount of tillage conducted. Maintaining surface residues has numerous benefits including increasing SOC and water capacity, increasing porosity, preventing erosion, and enhancing soil stability, especially when used in combination with cover crops.

As a result, adoption of no-till and reduced-tillage practices vary widely across regions and crops with only 20% of farmland using no-till practices continuously. While many associate no-till and cover cropping as the key, beneficial approaches in carbon sequestration and erosion prevision, the impact of various tillage practices is far more complicated; the amount of carbon which can be sequestered with these practices can vary widely based on soil composition, moisture-levels, topography, and other management decisions. The economic benefit of these practices must be established in an accurate, personalized manner for each farm in order to promote widespread trust and adoption.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a residue identification system including an image gathering unit that gathers at least one representation of a field and stiches the images together to produce a large single image of the field, an image analysis unit that generates residue map of the field, a residue analysis unit that processes the residue map to calculate a carbon emission of each area of the field.

In another embodiment, tillage practices used on the field are identified.

In another embodiment, a standard encoder-decoder is implemented with a U-Net to determine the distribution over a plausible level of residue segmentation of the field.

In another embodiment, a five channel image of the field is used as an input and a five channel image is returned.

In another embodiment, a fuse topology and the gathered images are used to determine crop type in the field.

In another embodiment, soil make up information, weather information and topology of the field are used to determine the carbon emissions.

In another embodiment, the residue levels are shown on an overlay to the images to identify areas of high, moderate, and low residue.

In another embodiment, the images are gathered by a drone flying 200 feet above the field.

In another embodiment, the field contains specialty crops.

In another embodiment, the drone gathers images using a RGB camera.

Another embodiment of the present disclosure includes a method of identifying residue in a field including the steps of gathering at least one representation of a field via an image gathering unit, stitching the images together to produce a large single image of the field via the image gathering unit, generating a residue map of the field via an image analysis unit, and processing the residue map to calculate a carbon emission of each area of the field via a residue analysis unit.

Another embodiment includes the step of identifying tillage practices used on the field.

In another embodiment, standard encoder-decoder is implemented with a U-Net to determine the distribution over a plausible level of residue segmentation of the field.

In another embodiment, a five channel image of the field is used as an input and a five channel image is returned.

In another embodiment, a fuse topology and the gathered images are used to determine crop type in the field.

In another embodiment, soil make up information, weather information and topology of the field are used to determine the carbon emissions.

In another embodiment, the residue levels are shown on an overlay to the images to identify areas of high, moderate, and low residue.

In another embodiment, the images are gathered by a drone flying 200 feet above the field.

In another embodiment, the field contains specialty crops.

In another embodiment, the drone gathers images using a RGB camera.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a residue identification analysis system 100 consistent with the present invention;

FIG. 2 depicts one embodiment of a residue analysis unit 102;

FIG. 3 depicts one embodiment of a communication device 104/106 consistent with the present invention; and

FIG. 4 depicts a schematic representation of a process used to calculate the residue segmentation of a field.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The residue identification system 100 gathers images from a drone aircraft flying at a low altitude. Each image is stitched together with adjacent images to provide single large scale view of the field where the specialty crops are being, or have been, grown. The system performs a series of steps to identify the type of crop planted in a field and whether the field is a till or no till field. Using the gathered information, each field is rated for residue segmentation and a carbon calculation is performed.

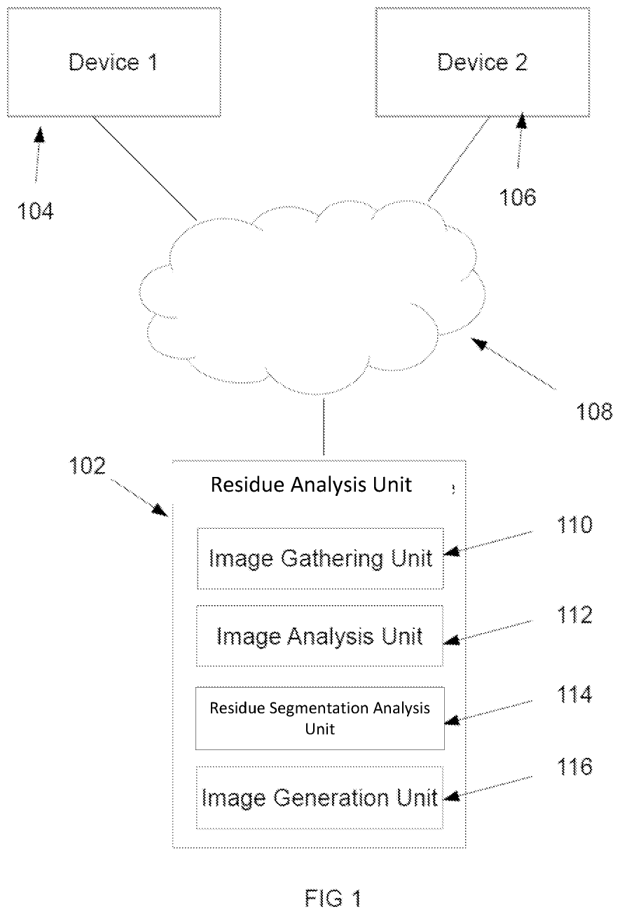

FIG. 1 depicts one embodiment of a residue identification system 100 consistent with the present invention. The residue identification system 100 includes a residue analysis unit 102, a communication device #1 104, a communication device #2 106 each communicatively connected via a network 108. The residue analysis unit 102 further includes an image gathering unit 110, an image analysis unit 112, a residue segmentation analysis unit 114 and an image generation unit 116.

The image gathering unit 110 and image analysis unit 112 may be embodied by one or more servers. Alternatively, each of the residue segmentation unit 114 and image generation unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the residue analysis unit 102 may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches. The image gathering unit 112 may be a digital camera. In one embodiment, the image gathering unit 112 is a three band (RGB) camera.

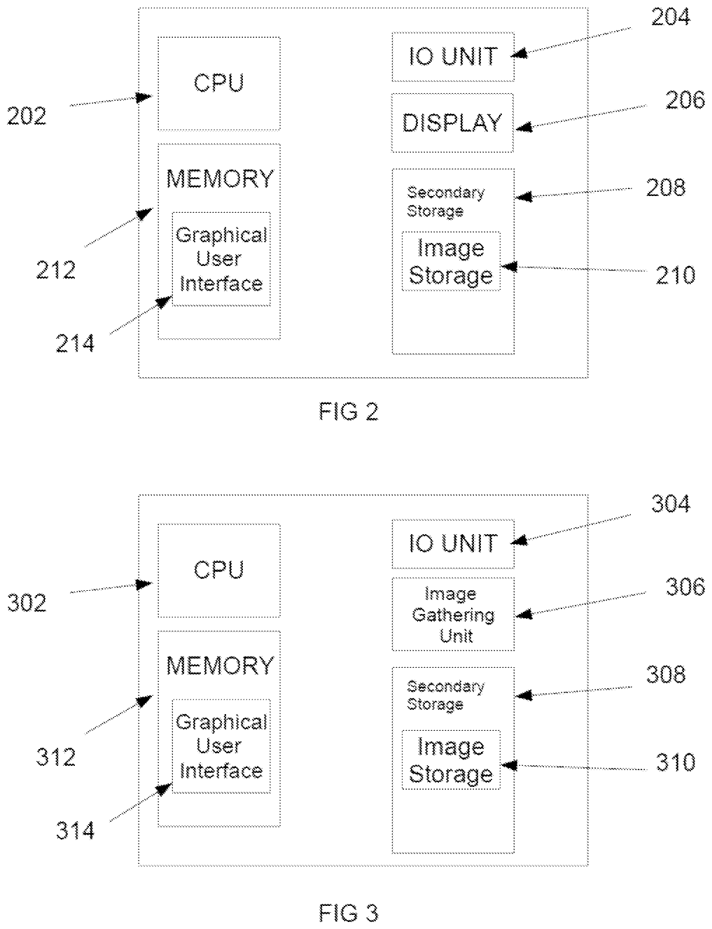

FIG. 2 depicts one embodiment of a residue analysis unit 102. The residue analysis unit 102 includes a network I/O device 204, a processor 202, a display 206 and a secondary storage 208 running image storage unit 210 and a memory 212 running a graphical user interface 214. The image gathering unit 112, operating in memory 208 of the residue analysis unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The residue segmentation 114 may be a compiled program running on a server, a process running on a microprocessor or any other suitable port control software.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

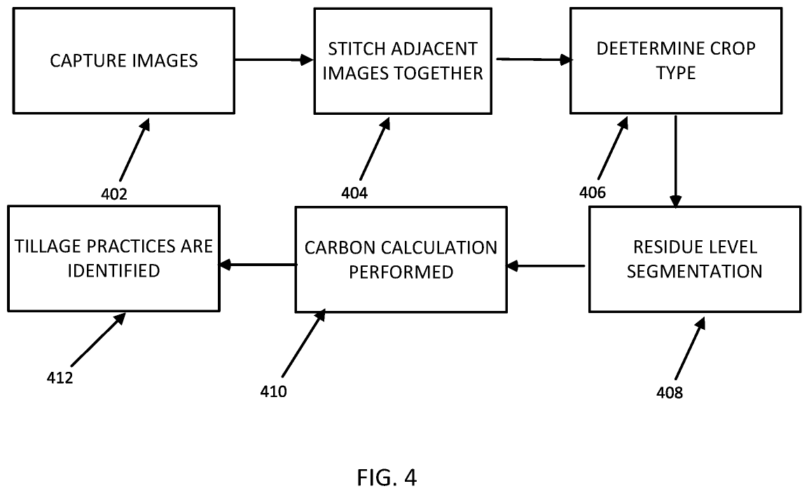

FIG. 4 depicts a schematic representation of a process used to calculate the residue segmentation of a field and associated carbon potential of areas in the field. In step 402, the image gathering unit 110 gathers aerial images of a crop field. The image may be captured using any conventional methods of capturing a digital image including using a drone aircraft equipped with a RGB camera. In one embodiment, a drone aircraft is flown 200 feet above a field of specialty crops. In step 404, the image analysis unit 112 stiches together adjacent images to produce a single image of an entire field. In step 406, the images are analyzed to determine the crop type. In one embodiment, standard encoder-decoders are implemented with a U-Net to determine the distribution over a plausible level of segmentation of the field. A five channel image of the field is used as an input and a five channel image is returned after the analysis. In another embodiment, fuse topology and the captured images are used to determine crop type. In step 408, the residue segmentation of the field is determined and, the residue levels are shown on an overlay to the images to identify areas of high, moderate, and low residue. In step 410, tillage practices are identified from the output of step 408 and in combination with the imagery. In step 412, a carbon calculation is used to determine potential carbon emissions of the residue areas by analyzing the images along with soil make up information, weather information and topology.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A residue identification system including:
an image gathering unit that gathers at least one representation of a field and stiches the images together to produce a large single image of the field;
an image analysis unit that generates residue map of the field;
a residue analysis unit that processes the residue map to calculate a carbon emission of each area of the field.

2. The residue identification system of claim 1 wherein tillage practices used on the field are identified.

3. The residue identification system of claim 1 wherein a standard encoder-decoder is implemented with a U-Net to determine the distribution over a plausible level of residue segmentation of the field.

4. The residue identification system of claim 1 wherein a five channel image of the field is used as an input and a five channel image is returned.

5. The residue identification system of claim 1 wherein a fuse topology and the gathered images are used to determine crop type in the field.

6. The residue identification system of claim 1 wherein soil make up information, weather information and topology of the field are used to determine the carbon emissions.

7. The residue identification system of claim 1 wherein the residue levels are shown on an overlay to the images to identify areas of high, moderate, and low residue.

8. The residue identification system of claim 1 wherein the images are gathered by a drone flying 200 feet above the field.

9. The residue identification system of claim 1 wherein the field contains specialty crops.

10. The residue identification system of claim 8 wherein the drone gathers images using a RGB camera.

11. A method of identifying residue in a field including the steps of:
gathering at least one representation of a field via an image gathering unit;
stitching the images together to produce a large single image of the field via the image gathering unit;
generating a residue map of the field via an image analysis unit;
processing the residue map to calculate a carbon emission of each area of the field via a residue analysis unit.

12. The method of claim 11 including the step of identifying tillage practices used on the field.

13. The method of claim 11 wherein a standard encoder-decoder is implemented with a U-Net to determine the distribution over a plausible level of residue segmentation of the field.

14. The method of claim 11 wherein a five channel image of the field is used as an input and a five channel image is returned.

15. The method of claim 11 wherein a fuse topology and the gathered images are used to determine crop type in the field.

16. The method of claim 11 wherein soil make up information, weather information and topology of the field are used to determine the carbon emissions.

17. The method of claim 11 wherein the residue levels are shown on an overlay to the images to identify areas of high, moderate, and low residue.

18. The method of claim 11 wherein the images are gathered by a drone flying 200 feet above the field.

19. The method of claim 11 wherein the field contains specialty crops.

20. The method of claim 18 wherein the drone gathers images using a RGB camera.
